(19) United States
(12) Patent Application Publication
(10) Pub. No.: US 2009/0153857 A1
(43) Pub. Date: Jun. 18, 2009

(54) Particle detector

(76) Inventor: Tomonobu Matsuda, Tokyo (JP)

Correspondence Address: CARRIER BLACKMAN AND ASSOCIATES, 24101 NOVI ROAD, SUITE 100, NOVI, MI, 48375, US

(21) Appl. No.: 11/630,764

(22) PCT Filed: Aug. 21, 2006
(86) PCT No.: PCT/JP2006/316334

§ 371 Date: Dec. 22, 2006

(30) Foreign Application Priority Data
Sep. 9, 2005 (JP) 2005-261428

(51) Int. Cl. G01N 21/53

(52) U.S. Cl. 356/339

(57) ABSTRACT

A particle detector which can detect smaller particles by increasing the pulse width of the particle signal output from a photoelectric transducer element, includes a particle monitoring region formed by irradiating sample fluid with laser light, and light scattered from particles passing through the particle monitoring region is received by a photoelectric transducer element so as to detect a particle. The direction of flow of the sample fluid and the direction of the laser light are arranged parallel to each other. The particle detector may have a condenser lens for condensing the scattered light and a slit provided at a focal point of the condenser lens and extending in a direction parallel to the sample fluid flow. Also, the particle detector may have a condenser circuit for integrating the output signal of the photoelectric transducer element, and a low-pass filter for filtering the output signal of the condenser circuit.

### TECHNICAL FIELD

The present invention relates to a particle detector which can detect fine particles contained in sample fluid.

### BACKGROUND ART

In a conventional particle detector, laser light is directed perpendicularly or at an angle toward sample fluid flowing through a flow cell, and light scattered by fine particles contained in the sample fluid is detected by a photoelectric transducer element (for example, Patent Document 1). In this instance, when particles pass laser light, scattered light is generated. Accordingly, the output signal (particle signal) of the photoelectric transducer element becomes a pulse.

These days, high-density and high-accuracy fine processing is required to manufacture precise electronic devices, and high purity is required with respect to the ultra-pure water or chemical liquid used therein. In order to control such purity, a particle detector is used. As for ultra-pure water, it is necessary to measure and control fine particles whose diameter is less than 0.05 μm. In order to detect such fine particles, a technique in which the energy density of the laser beam is increased by narrowing the laser beam has been used.

Patent Document 1: Japanese Patent No. 3521381

In the particle detector disclosed in Patent Document 1, since the laser light is narrowed, the period of time in which the particles pass the laser light becomes shorter. Therefore, the pulse width of the particle signal becomes shorter, which makes it difficult to detect the particles.

The pulse width of the particle signal is determined by dividing the beam diameter of the laser light in the particle monitoring region by the flow velocity of the particles. Also, in order to control high purity, it is necessary to measure smaller particles in a larger amount of sample fluid. Therefore, it is necessary to increase the flow velocity of the sample fluid and decrease the beam diameter. However, according to the conventional structure, since the pulse width of the particle signal is as small as several μ seconds—several tens μ seconds, it is difficult to distinguish from noise due to outside light, noise due to the laser, or electric noise.

The present invention was created to solve the above-mentioned drawbacks of the conventional technique. The object of the present invention is to provide a particle detector which can detect smaller particles by increasing the pulse width of the particle signal output from a photoelectric transducer element.

### DISCLOSURE OF THE INVENTION

In order to solve the above-mentioned drawbacks, according to an aspect of the present invention, there is provided a particle detector in which a particle monitoring region is formed by irradiating sample fluid with a light beam, and light scattered by particles passing through the particle monitoring region is received by a photoelectric transducer element so as to detect a particle, wherein the direction of flow of the sample fluid and the direction of the light beam are parallel to each other.

According to another aspect of the present invention, the above-mentioned particle detector further comprises a condenser means for condensing the scattered light.

According to another aspect of the present invention, the above-mentioned particle detector further comprises a slit provided at a focal point of the condenser means in a direction parallel to the sample fluid.

According to another aspect of the present invention, the above-mentioned condenser means is a condenser lens.

According to another aspect of the present invention, the above-mentioned condenser means is a concave mirror.

According to another aspect of the present invention, the above-mentioned particle detector further comprises an integrator means for integrating the output signal of the photoelectric transducer element.

According to another aspect of the present invention, the above-mentioned particle detector further comprises a frequency filter for filtering the output signal of the photoelectric transducer element.

### BRIEF DESCRIPTION OF THE DRAWINGS

FIG. 1 is a diagram of the first embodiment of a particle detector according to the present invention;

FIG. 2 is a front view of a photoelectric transducer element seen from a slit of the first embodiment;

FIG. 3 is a diagram of the photoelectric transducer element and a signal processing means;

FIG. 4 shows output waveforms of the photoelectric transducer element and each element of the signal processing means, in which FIG. 4(a) shows an output waveform of the photoelectric transducer element, FIG. 4(b) shows an output waveform of a condenser circuit, FIG. 4(c) shows an output waveform of an amplifier, FIG. 4(d) shows an output waveform of a low-pass filter, and FIG. 4(e) shows an output waveform of a detecting portion;

FIG. 5 is a diagram of the second embodiment of a particle detector according to the present invention; and

FIG. 6 is a front view of a photoelectric transducer element seen from a slit according to the second embodiment.

### BEST MODE FOR CARRYING OUT THE INVENTION

Preferred embodiments of the present invention will now be described with reference to the accompanying drawings.

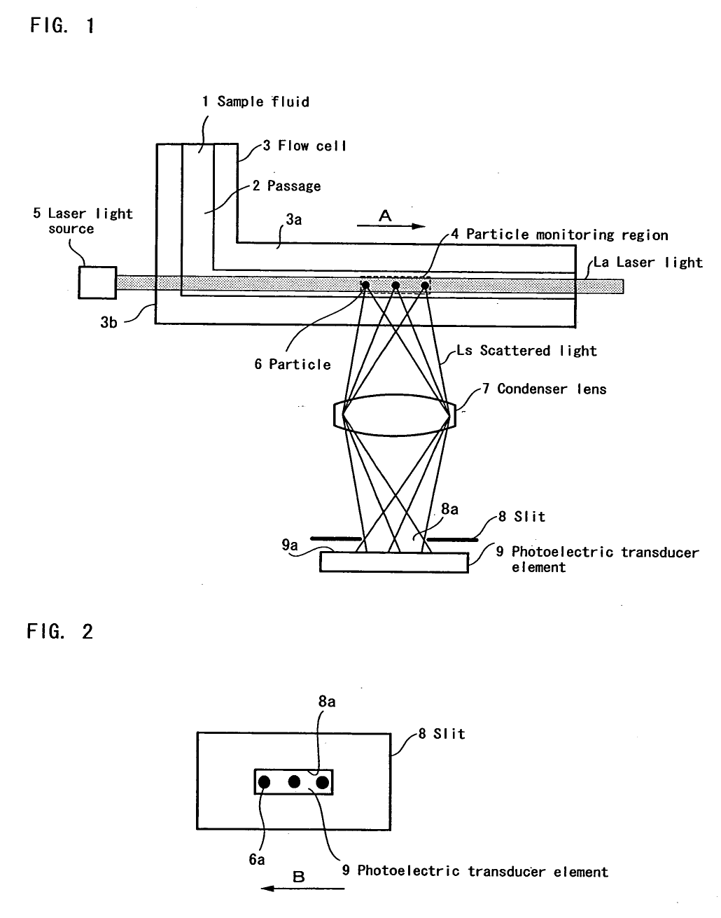

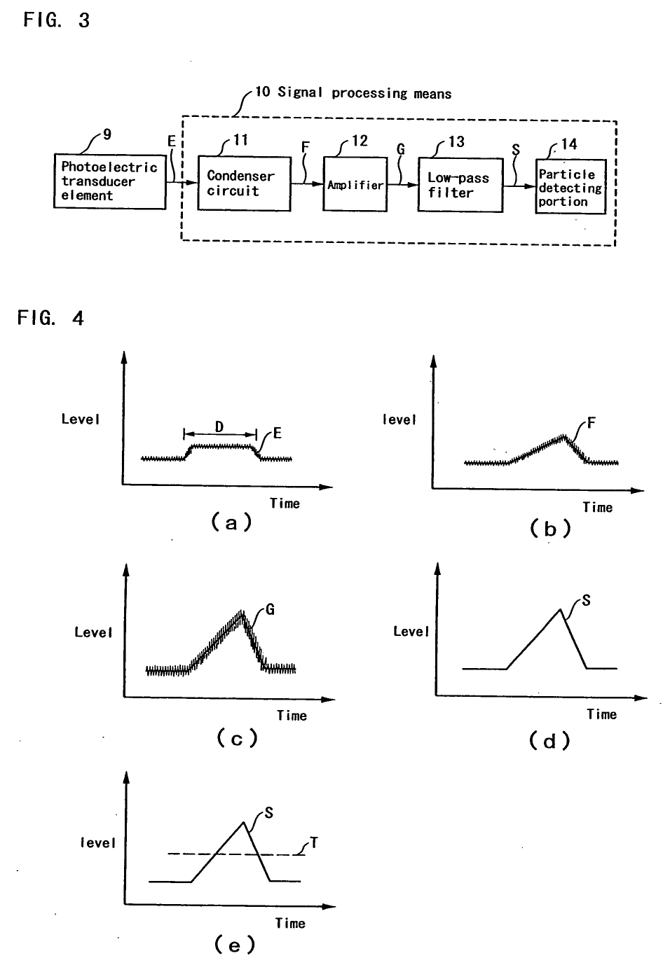

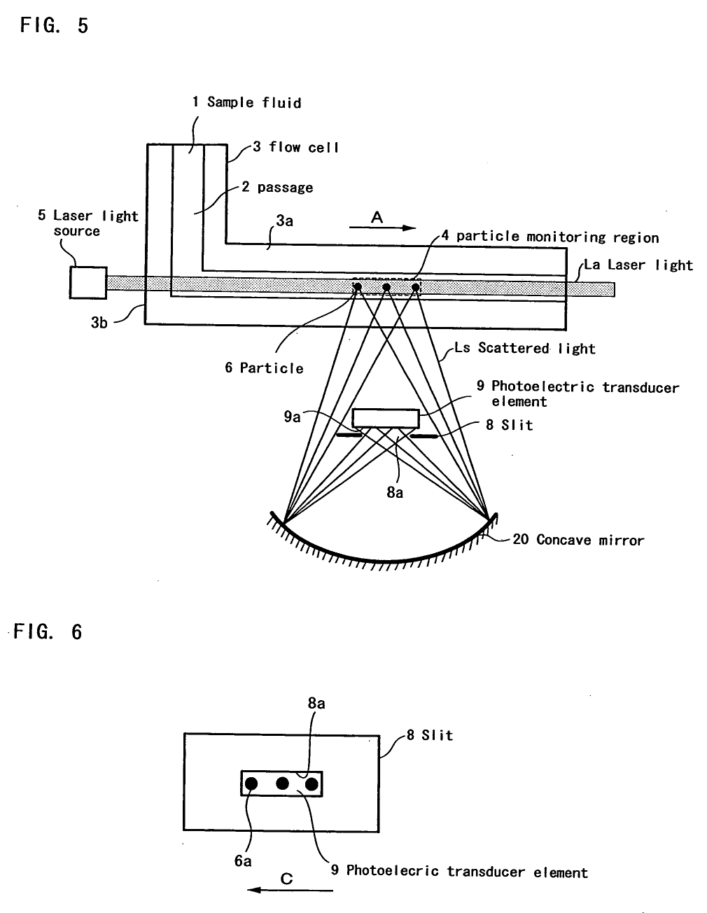

FIG. 1 is a diagram of the first embodiment of a particle detector according to the present invention, FIG. 2 is a front view of a photoelectric transducer element seen from a slit of the first embodiment, FIG. 3 is a diagram of the photoelectric transducer element and a signal processing means, FIG. 4 shows output waveforms of the photoelectric transducer element and each element of the signal processing means, FIG. 5 is a diagram of the second embodiment of a particle detector according to the present invention, and FIG. 6 is a front view of a photoelectric transducer element seen from a slit according to the second embodiment.

As shown in FIG. 1, the particle detector of the first embodiment is comprised of a flow cell 3, provided with a passage 2 through which the sample fluid 1 flows, a laser light source 5 for irradiating the passage 2 with laser light La so as to form a particle monitoring region 4, a condenser lens 7 for condensing scattered light Ls generated by particles 6 passing through the particle monitoring region 4, a slit 8 for blocking unwanted light from outside, and a photoelectric transducer element 9 for converting light condensed by the condenser lens 7 into a voltage corresponding to the intensity of the light.

The flow cell 3 is made of a transparent material, and is provided with a linear passage 3a of a predetermined length. The flow cell 3 is bent as a whole. In addition, the cross section of the flow cell 3 has a rectangular shape, and the whole shape of the flow cell 3 is an L-shaped tube. The reason the flow cell 3 has the linear passage 3a of a predetermined length is to make the flow of the sample fluid 1a laminar flow. The conditions for obtaining a laminar flow are the viscosity of the sample fluid 1, the length of the linear passage, the cross-sectional shape of the passage, the velocity of the flow, and so on. The length of the linear passage 3a and the cross-sectional shape of the passage are determined by the viscosity and the velocity of the sample fluid 1.

The laser light source 5 radiates laser light La, irradiating the linear passage 3a of the flow cell 3 so as to form the particle monitoring region 4. The optical axis of the laser light La corresponds to the central axis of the linear passage 3a. Also, the angle between the optical axis of the laser light La and the perpendicular of an outer wall 3b of the flow cell 3 may be arranged to be a predetermined angle θ. With this, it is possible to prevent some of the light reflected on the outer wall 3b of the flow cell 3 from returning to the laser light source 5.

If some of the reflected light returns to the laser light source 5, undesired feedback noise is superposed on the laser light La. In this instance, the central axis of the laser light is not parallel to the central axis of the passage 2. However, there is no problem if the predetermined angle θ is adjusted to be sufficiently small. Incidentally, if the laser light La is introduced into a predetermined place of the linear passage 3a by allowing the laser light La to pass through the same material as the outer wall 3b of the flow cell 3, there is no need to arrange the predetermined angle θ.

The condenser lens 7 has an optical axis perpendicular to the central axis of the linear passage 3a of the flow cell 3, and condenses scattered light Ls generated by particles 6 irradiated with the laser light La in the particle monitoring region 4. The slit 8 is provided with a slit aperture 8a, and the longitudinal direction of the slit aperture 8a corresponds to the direction of the optical axis of the laser light La. The slit 8 is positioned at a focal point of the condenser lens 7 on the opposite side of the flow cell 3. The slit 8 allows scattered light Ls generated by particles 6 in the particle monitoring region 4 to pass through while blocking outside light as shown in FIG. 2. The area of the particle monitoring region 4 is determined by the size of the slit aperture 8a of the slit 8.

The photoelectric transducer element 9 is provided with a light receiving surface 9a which is parallel to the slit 8. The photoelectric transducer element 9 is positioned on the opposite side of the condenser lens 7 with respect to the slit 8. The photoelectric transducer element 9 converts the scattered light Ls passing through the slit 8 into a voltage. Incidentally, when the angle between the optical axis of the laser light La and the outer wall 3b of the flow cell 3 is arranged to be a predetermined angle θ, the slit 8 and the light receiving surface 9a of the photoelectric transducer element 9 are arranged to be parallel to the optical axis of the laser light La.

Also, as shown in FIG. 3, a signal processing means 10 is connected to the photoelectric transducer element 9. The signal processing means 10 is comprised of a condenser circuit 11 as an integrator means, an amplifier 12, a low-pass filter 13 as a frequency filter, and a detecting portion 14 for detecting a particle signal. The condenser circuit 11 is connected to the output of the photoelectric transducer element 9 in series so as to output a signal in which the output signal of the photoelectric transducer element 9 has been integrated. The amplifier 12 amplifies the output signal of the condenser circuit 11 to a predetermined level. The low-pass filter 13 removes the high-frequency noise component from the output signal of the amplifier 12. The detecting portion 14 detects a pulse signal as a particle signal from the output signal of the low-pass filter 13. Incidentally, a photoelectric transducer element having a storage effect such as a charge-coupled device (CCD) may be used instead of the photoelectric transducer element 9 and the condenser circuit 11.

Next, the operation of the particle detector according to the first embodiment of the present invention will be described.

Sample fluid 1 containing particles 6 is allowed to flow through the passage 2 of the flow cell 3 in the direction of arrow A. Laser light La radiated from the laser light source 5 overlaps with the passage 2 formed by the linear passage 3a of the flow cell 3 so that part of the overlapping area becomes the particle monitoring region 4. The particles 6 moving through the passage 2 which overlaps with the laser light La keep generating scattered light Ls.

The scattered light Ls generated by the particles 6 is condensed by the condenser lens 7, and the images 6a of the particles 6 are formed at the position of the slit aperture 8a as shown in FIG. 2. As the particles 6 move through the particle monitoring region 4, the images 6a of the particles 6 formed by the condenser lens 7 move in the direction of arrow B reverse to the direction of movement of the particles 6. Further, the images 6a of the particles 6 pass through the slit 8 and reach the photoelectric transducer element 9. In this way, the photoelectric transducer element 9 is continuously irradiated with the scattered light Ls while the particles 6 are moving through the particle monitoring region 4.

As shown in FIG. 4(a), the output signal E of the photoelectric transducer element 9 irradiated with the scattered light Ls is a minute signal that includes noise despite the pulse width D maintained to some extent. Therefore, the condenser circuit 11 is connected to the photoelectric transducer element 9 in series, so that the signal is integrated by the time of the pulse width D. In this way, the level of the output signal F of the condenser circuit 11 is increased, and the signal-to-noise ratio is increased. Further, the output signal F of the condenser circuit 11 is amplified by the amplifier 12 so as to achieve the output signal G of the amplifier 12 as shown in FIG. 4 (c).

Next, the high-frequency component is removed from the output signal G of the amplifier 12 by the low-pass filter 13 so as to generate a pulse signal S which corresponds to the particle as shown in FIG. 4 (d). When the pulse signal S as the output signal of the low-pass filter 13 is input into the detecting portion 14 comprised of a threshold circuit, the pulse signal S exceeds a threshold T. Consequently, the pulse signal S can be easily distinguished from noise due to outside light, and is recognized as a particle signal.

Next, as shown in FIG. 5, the particle detector of the second embodiment is comprised of a flow cell 3 provided with a passage 2 through which the sample fluid 1 flows, a laser light source 5 for irradiating the passage 2 with laser light La so as to form a particle monitoring region 4, a concave mirror 20 for condensing scattered light Ls generated by particles 6 passing through the particle monitoring region 4, a slit 8 for intercepting unwanted light from outside, and a photoelectric transducer element 9 for converting light condensed by the concave mirror 20 into a voltage corresponding to the intensity of the light.

The concave mirror 20 has an optical axis perpendicular to the central axis of the linear passage 3a of the flow cell 3, and condenses scattered light Ls generated by particles 6 irradiated with the laser light La in the particle monitoring region 4. The slit 8 is provided with a slit aperture 8a, and the longitudinal direction of the slit 8a corresponds to the optical axis of the laser light La. The slit 8 is positioned at a focal point of the concave mirror 20 on the opposite side of the flow cell 3. The slit 8 allows scattered light Ls generated by particles 6 in the particle monitoring region 4 to pass and blocks light from outside as shown in FIG. 6.

The photoelectric transducer element 9 is provided with a light receiving surface 9a which is parallel to the slit 8. The photoelectric transducer element 9 is positioned on the opposite side of the concave mirror 20 with respect to the slit 8. The images 6a of the particles 6 formed by the concave mirror 20 move in the direction of arrow C reverse to the moving direction of the particles 6. The area of the particle monitoring region 4 is determined by the size of the slit aperture 8a of the slit 8.

Also, as shown in FIG. 3, a signal processing means 10 is connected to the photoelectric transducer element 9. The signal processing means 10 is comprised of a condenser circuit 11 as an integrator means, an amplifier 12, a low-pass filter 13 as a frequency filter, a detecting portion 14 for detecting a particle signal. Since the structure of the second embodiment is the same as the first embodiment except that the scattered light Ls is condensed by the concave mirror 20, the explanation of the detailed structure and the operation is omitted.

### INDUSTRIAL APPLICABILITY

Since the particle detector of the present invention can reliably detect fine particles, it can be used to control the high purity of ultra-pure water or chemical liquids used in the manufacturing of precise electronic devices. It is expected that the demand for by industry for this technology will be high.

1. A particle detector in which a particle monitoring region is formed by irradiating a flowing sample fluid with a light beam, and light scattered by particles passing through the particle monitoring region is received by a photoelectric transducer element so as to detect a particle, wherein a direction of flow of the sample fluid and a direction of the light beam are arranged parallel to each other.

2. The particle detector according to claim 1, further comprising a condenser which condenses the scattered light.

3. The particle detector according to claim 2, further comprising a member with a slit provided at a focal point of the condenser means and extending in a direction parallel to the direction of flow of the sample fluid.

4. The particle detector according to claim 2, wherein the condenser is a condenser lens.

5. The particle detector according to claim 2, wherein the condenser is a concave mirror.

6. The particle detector according to claim 2, further comprising an integrator which integrates an output signal of the photoelectric transducer element.

7. The particle detector according to claim 2, further comprising a frequency filter which filters an output signal of the photoelectric transducer element.

8. The particle detector according to claim 3, wherein the condenser is one of a condenser lens and a concave mirror.

9. The particle detector according to claim 3, further comprising an integrator which integrates an output signal of the photoelectric transducer element.

10. The particle detector according to claim 8, further comprising an integrator which integrates an output signal of the photoelectric transducer element.

11. The particle detector according to claim 3, further comprising a frequency filter which filters an output signal of the photoelectric transducer element.

12. The particle detector according to claim 8, further comprising a frequency filter which filters an output signal of the photoelectric transducer element.

13. The particle detector according to claim 10, further comprising a frequency filter which filters an output signal of the photoelectric transducer element.

14. The particle detector according to claim 1, further comprising a flow cell having a passage through which the sample fluid flows, and a laser light source which generates said light beam.

15. The particle detector according to claim 14, wherein the direction of the light beam is substantially parallel to a central axis of a portion of said passage in which the particle monitoring region is defined.

16. The particle detector according to claim 14, wherein the direction of the light beam extends at a small angle from parallel to a central axis of a portion of said passage in
